(19) United States
(12) Patent Application Publication
(10) Pub. No.: US 2026/0289333 A1
(43) Pub. Date: Sep. 24, 2026

(54) INTENT RECOGNITION MODEL TRAINING AND USER INTENT RECOGNITION

(71) Applicant: Alipay (Hangzhou) Information Technology Co., Ltd., Hangzhou (CN)

(72) Inventors: Zhenzhe YING, Hangzhou (CN); Haotian WANG, Hangzhou (CN); Weiqiang WANG, Hangzhou (CN)

(21) Appl. No.: 18/868,596

(22) PCT Filed: May 19, 2023
(86) PCT No.: PCT/CN2023/095201

§ 371 Date: Nov. 22, 2024

(30) Foreign Application Priority Data
Jun. 22, 2022 (CN) 202210713723.0

(51) Int. Cl. G06N 5/022; G06F 40/35

(52) U.S. Cl. CPC G06N 5/022; G06F 40/35

(57) ABSTRACT

This specification discloses an intention recognition model training method and apparatus, and a user intention recognition method and apparatus. Historical conversation data including a plurality of rounds of conversation are first determined as a training sample; a user intention of each round of conversation in each training sample is determined by using a first intention recognition model; a feedback intention is determined based on a service that corresponds to the training sample and that is executed by a user; each prediction intention of the training sample and a second risk identification result are determined by using a second intention recognition model; and finally, the second intention recognition model is trained with an optimization objective of minimizing a difference between the first risk identification result and the second risk identification result that are of each training sample.

### TECHNICAL FIELD

This application relates to the field of computer technologies, and in particular, to intention recognition model training and user intention recognition.

### BACKGROUND

Currently, with rapid development of the Internet, an interactive risk control technology also continuously develops. In an application scenario of interactive risk control, a service platform can implement two-way communication with a user by making an outgoing call, to find a behavior risk of the user in a timely manner, and perform behavior dissuasion or risk prompt for the user. Therefore, whether the behavior risk of the user can be accurately found in a timely manner is a problem that needs to be mainly considered.

This specification provides an intention recognition model training method and a model-based user intention recognition method, to find a behavior risk of a user in a timely manner, and improve timeliness and accuracy of risk control.

### SUMMARY

Embodiments of this specification provide an intention recognition model training method and apparatus, and a user intention recognition method and apparatus, to at least partially resolve a problem in the conventional technology.

The following technical solutions are used in this specification: This specification provides an intention recognition model training method, including: determining each training sample based on historical conversation data, where the training sample includes a plurality of rounds of conversation; for each training sample, determining, as a first label of the training sample, a user intention of each round of conversation in the training sample by using a first intention recognition model whose training is completed; determining, based on the training sample, a preorder service that corresponds to the training sample and that is executed by a user, to determine a subsequent service that corresponds to the preorder service and that is executed by the user, and determining, as a second label corresponding to the training sample, a feedback intention based on conversation data corresponding to the subsequent service; determining a first risk identification result corresponding to the training sample based on the first label and the second label that correspond to the training sample; inputting the training sample into a to-be-trained second intention recognition model, and determining each prediction intention and a second risk identification result that correspond to the training sample; and determining a loss based on a difference between the first risk identification result and the second risk identification result of each training sample, and training the to-be-trained second intention recognition model with an optimization objective of minimizing the loss, where the second intention recognition model is used to jointly recognize, with the first intention recognition model, a risk caused by a false intention of the user in conversation.

This specification provides a user intention recognition method, including: inputting conversation data in a current round into a first intention recognition model, and determining a first intention corresponding to the conversation data in the current round of the user; determining a risk identification result corresponding to the conversation data based on first intentions corresponding to the conversation data in all the performed rounds; when it is determined, based on the risk identification result, that there is no risk, inputting conversation data in a specified currently performed round into a second intention recognition model, to determine all second intentions corresponding to the input conversation data; determining whether there is a difference between a first intention and all the second intentions that correspond to the conversation data in the specified performed round; and if yes, determining that there is a risk caused by a false intention of the user, and notifying the user that there is a risk. The second intention recognition model is obtained through training by using several pieces of historical conversation data as training samples and based on a first risk identification result determined based on a feedback intention corresponding to each training sample and a user intention determined by the first intention recognition model and each prediction intention and a second risk identification result that are determined by the second intention recognition model.

This specification provides an intention recognition model training apparatus, including: a training sample determining module, configured to determine each training sample based on historical conversation data, where the training sample includes a plurality of rounds of conversation; a first label determining module, configured to: for each training sample, determine, as a first label of the training sample, a user intention of each round of conversation in the training sample by using a first intention recognition model whose training is completed; a second label determining module, configured to: determine, based on the training sample, a preorder service that corresponds to the training sample and that is executed by a user, to determine a subsequent service that corresponds to the preorder service and that is executed by the user, and determine, as a second label corresponding to the training sample, a feedback intention based on conversation data corresponding to the subsequent service; a first risk identification module, configured to determine a first risk identification result corresponding to the training sample based on the first label and the second label that correspond to the training sample; a second risk identification module, configured to: input the training sample into a to-be-trained second intention recognition model, and determine each prediction intention and a second risk identification result that correspond to the training sample; and a training module, configured to: determine a loss based on a difference between the first risk identification result and the second risk identification result of each training sample, and train the to-be-trained second intention recognition model with an optimization objective of minimizing the loss, where the second intention recognition model is used to jointly recognize, with the first intention recognition model, a risk caused by a false intention of the user in conversation.

This specification provides a user intention recognition apparatus, including: an obtaining module, configured to obtain conversation data in all rounds currently performed by a user; a first intention determining module, configured to: input conversation data in a current round into a first intention recognition model, and determine a first intention corresponding to the conversation data in the current round of the user; a first risk determining module, configured to determine a risk identification result corresponding to the conversation data based on first intentions corresponding to the conversation data in all the performed rounds; a second intention determining module, configured to: when it is determined, based on the risk identification result, that there is no risk, input conversation data in a specified currently performed round into a second intention recognition model, to determine all second intentions corresponding to the input conversation data; and a second risk determining module, configured to: determine whether there is a difference between a first intention and all the second intentions that correspond to the conversation data in the specified performed round; and if yes, determine that there is a risk caused by a false intention of the user, and notify the user that there is a risk.

This specification provides a non-transitory computer-readable storage medium. The storage medium stores a computer program, and when the computer program is executed by a processor, the intention recognition model training method or the user intention recognition method is implemented.

This specification provides an electronic device, including a storage, a processor, and a computer program that is stored in the storage and that is capable of running on the processor. When the processor executes the computer program, the intention recognition model training method or the user intention recognition method is implemented.

The above-mentioned at least one technical solution used in this specification can achieve the following beneficial effects: According to the intention recognition model training method and apparatus, and the user intention recognition method and apparatus that are provided in this specification, historical conversation data including a plurality of rounds of conversation are first determined as a training sample; a user intention of each round of conversation in each training sample is determined by using a first intention recognition model; a feedback intention is determined based on a service that corresponds to the training sample and that is executed by a user; a first risk identification result is determined based on a user intention and the feedback intention that are of the training sample; each prediction intention of the training sample and a second risk identification result are determined by using a second intention recognition model; and finally, the second intention recognition model is trained with an optimization objective of minimizing a difference between the first risk identification result and the second risk identification result that are of each training sample. An accurate risk identification result is obtained with reference to the feedback intention and the user intention determined by the first intention recognition model, to train the second intention recognition model, thereby improving a risk identification capability of the second intention recognition model.

### BRIEF DESCRIPTION OF DRAWINGS

The accompanying drawings described here are used to provide a further understanding of this specification, and constitute a part of this specification. Example embodiments of this specification and descriptions of the embodiments are used to explain this specification, and do not constitute an inappropriate limitation on this specification. In the accompanying drawings:

FIG. 1 is a schematic diagram of an intention recognition model training procedure according to this specification;

FIG. 2 is a schematic flowchart of a user intention recognition procedure according to this specification;

FIG. 3 is a schematic diagram of an intention recognition model training apparatus according to this specification;

FIG. 4 is a schematic diagram of a user intention recognition apparatus according to this specification; and

FIG. 5 is a schematic diagram of an electronic device that implements an intention recognition model training method or a user intention recognition method according to this specification.

### DESCRIPTION OF EMBODIMENTS

To make the objectives, technical solutions, and advantages of this specification clearer, the following clearly and comprehensively describes the technical solutions of this application with reference to specific embodiments and corresponding accompanying drawings of this specification. Clearly, the described embodiments are merely some rather than all of the embodiments of this specification. All other embodiments obtained by a person of ordinary skill in the art based on the embodiment of this specification without creative efforts shall fall within the protection scope of this application.

With rapid development of the Internet, more users complete various requirements through the Internet, for example, network shopping, network transfers, and take-out reservation. Due to network hiding, the user may encounter behaviors such as network fraud that impair interests of the user. Therefore, to protect the interests of the user, a server of a service platform usually needs to perform user operation-related conversation with the user, to determine whether an operation behavior of the user has a risk, so as to find a risk in a timely manner and prompt the user, and prevent the interests of the user from being damaged.

Usually, the server of the service platform can complete communication with the user through a plurality of rounds of conversation by making an outgoing call, actively initiating conversation chatting, etc., so that whether a user intention displayed in replies of each round of conversation is recognized based on a result of the round of conversation and by using a pre-trained model. However, the user may be in a deceived state, and cannot fully cooperate with the service platform. In this case, the server of the service platform cannot correctly recognize the user intention based on only a result of a single round of conversation. Consequently, whether an operation behavior of the user has a risk cannot be found in a timely manner, and timeliness and accuracy of risk control are relatively low.

The following describes in detail the technical solutions provided in the embodiments of this application with reference to the accompanying drawings.

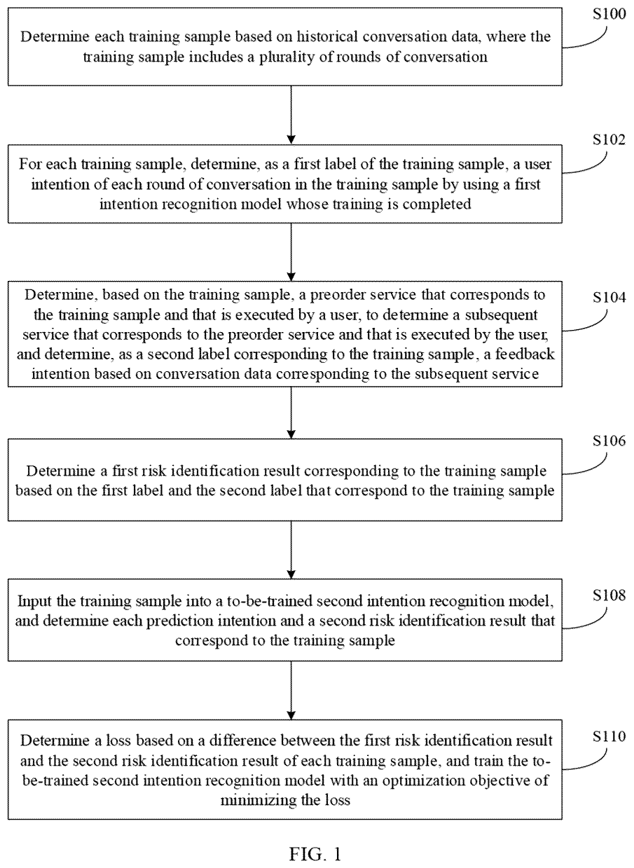

FIG. 1 is a schematic diagram of an intention recognition model training procedure according to this specification. The following steps are specifically included. S100: Determine each training sample based on historical conversation data, where the training sample includes a plurality of rounds of conversation.

Usually, a server of a service platform can actively communicate with a user through simple conversation by making an outgoing call, etc. based on user data. In a conversation process, specific conversation content can be stored, to be applied to another service. Based on this, in one or more embodiments of this specification, the server of the service platform can obtain several pieces of historical conversation data, determine each training sample, and perform model training. The training sample can include a plurality of rounds of conversation.

The obtained historical conversation data can be all conversation text, or can be a combination of a unique code of a question and a corresponding user reply. Usually, the server of the service platform can preset a plurality of question templates, and then generate a question adaptively based on a specific user and a specific user operation. Therefore, each question template can be encoded in advance, and each question template is provided with a unique identifier. In this case, during storage, only a code of the question template and text content of the user reply can be stored. Correspondingly, the server of the service platform can obtain the code of the question and the corresponding user reply.

Certainly, when the server of the service platform communicates with the user by making an outgoing call, voice recognition can be performed on a user voice collected in an outgoing call process, and the text content that is of the user reply and that is obtained through recognition is stored, so that the server of the service platform can obtain the code pf the question and the corresponding user reply. If communication with the user is not performed by using a voice call, the code of the question template and the user reply can be directly stored correspondingly.

In addition, the server of the service platform usually needs to perform a plurality of rounds of conversation with the user, and repeatedly determine, from a plurality of perspectives, whether a behavior of the user has a risk. Therefore, the historical conversation data obtained by the server includes a code of a question template corresponding to the plurality of rounds of conversation and the user reply.

The server mentioned in this specification can be a server disposed on a service platform, or a device such as a desktop computer or a laptop computer that can execute the solution in this specification. For ease of description, the following provides descriptions only by using an example in which the server is an execution body.

After the several pieces of historical conversation data are obtained, in one or more embodiments of this specification, the server of the service platform can further pre-train a second intention recognition model based on the obtained several pieces of historical conversation data. Specifically, the server can randomly replace at least a part of user replies in each piece of historical conversation data by using a placeholder, to obtain each pre-training sample, and use each replaced user reply as a conversation label corresponding to each pre-training sample. Therefore, the replaced user reply can be subsequently predicted based on other conversation data by using the to-be-trained second intention recognition model, to learn of a capability of performing inference based on context. Replacing the at least a part of user replies in each piece of historical conversation data can be masking a user reply of some conversation in the plurality of rounds of conversation.

After obtaining each pre-training sample and a corresponding conversation label, the server can first pre-train the to-be-trained second intention recognition model based on each pre-training sample and the conversation label.

The second intention recognition model can be a BERT model, and the BERT model can be a pre-trained general language representation model, to reduce a training amount. In addition, it is considered that, in a model application process, a model needs to provide feedback in real time based on an operation result. Therefore, a BERT model with a relatively small quantity of layers can be used, to improve operation efficiency, and reduce operation time. For example, a six-layer BERT model can be used. Certainly, a specific model can be determined based on a requirement. This is not limited in this specification.

Specifically, the server can input the pre-training sample into an input layer of the to-be-trained second intention recognition model, and determine a prediction statement corresponding to each replaced user reply by using a first output layer of the second intention recognition model. That is, a masked user reply is predicted, by using the second intention recognition model, word by word or phrase by phrase based on a relationship between unreplaced conversation data and a question corresponding to a replaced user reply and based on a quantity of words of an extracted user reply, to determine a prediction statement.

Therefore, the server can determine a loss based on a difference between the prediction statement and the conversation label that correspond to each pre-training sample, and pre-train the second intention recognition model with an optimization objective of minimizing the loss, until a training end condition is reached, to determine a second intention recognition model through pre-training, so that the second intention recognition model can learn of a capability of performing inference based on context.

A specific manner of embodying a difference between the prediction statement and a label answer can be determined based on a requirement. This is not limited in this specification. For example, a similarity between the prediction statement and the label answer can be computed based on a Levenshtein (LEV) distance, a longest common subsequence (LCS), etc. A higher similarity indicates a smaller difference. A pre-training end condition can be set based on a requirement. This is not limited in this specification.

After pre-training is performed based on a large quantity of pre-training samples, the second intention recognition model can master a capability of performing inference based on context at a statement level.
S102: For each training sample, determine, as a first label of the training sample, a user intention of each round of conversation in the training sample by using a first intention recognition model whose training is completed.
S104: Determine, based on the training sample, a preorder service that corresponds to the training sample and that is executed by a user, to determine a subsequent service that corresponds to the preorder service and that is executed by the user, and determine, as a second label corresponding to the training sample, a feedback intention based on conversation data corresponding to the subsequent service.

After the training sample is obtained, in one or more embodiments of this specification, the server can further train the second intention recognition model based on each training sample, historical intention recognition information corresponding to each training sample, and a feedback behavior performed by the user.

Therefore, for the historical intention recognition information corresponding to each training sample, the server can perform the following operation: for each training sample, determining, as a first label of the training sample, a user intention of each round of conversation in the training sample by using a first intention recognition model whose training is completed.

The first intention recognition model can be an intention recognition model used by the server when historical conversation occurs. For each training sample, the server can first input each round of conversation in the historical conversation data corresponding to the training sample into the first intention recognition model whose training is completed, determine the user intention corresponding to each round of conversation, and determine the first label corresponding to the training sample based on the user intention corresponding to each round of conversation. The user intention of each round of conversation is all intentions obtained by correspondingly recognizing each round of conversation, and can include one or more intentions.

For example, if the historical conversation data corresponding to the training sample includes conversation data in three rounds, the server can input conversation data in each round into the first intention recognition model, determine a user intention corresponding to conversation data in each round by using the first intention recognition model, and then use, as each user intention of the historical conversation data corresponding to the training sample, user intentions respectively obtained from the conversation data in the three rounds.

Specifically, how the first intention recognition model determines the user intention based on the conversation data can be determined based on a requirement. This is not limited in this specification. For example, the first intention recognition model can perform named entity recognition based on the user reply, so that intention information corresponding to the user reply can be extracted based on the user reply. For the historical conversation data, during conversation, if the server puts a question “What commodity are you buying?” and makes a corresponding user reply “I'm buying furniture”, the server can extract intention information corresponding to the user (transaction objective: furniture) based on the user reply “I'm buying furniture” by using the first intention recognition model. Descriptions are provided above by using an example in which one round of conversation includes one intention. However, this specification sets no limitation on a specific quantity of intentions obtained by recognizing each round of conversation.

Certainly, the extracted entity can be further classified, to determine a further user intention. For example, furniture can be classified into an entity type, a virtual type, a risk type, and a risk-free type. Therefore, the server can extract, by using the first intention recognition model, the intention information corresponding to the user (transaction objective: an entity is risk-free) based on the user reply “I'm buying furniture”. The above-mentioned descriptions are merely an example. This specification sets no limitation on a specific manner in which an intention is embodied.

In addition, in one or more embodiments of this specification, in addition to determining the intention label of each training sample by using the first intention recognition model, when historical conversation occurs, the server can further store, in a correspondence, each user intention and the historical conversation that are obtained by the first intention recognition model through recognition at a historical moment. In this case, the server can subsequently directly obtain, as an intention label of each training sample, each stored user intention of the historical conversation data corresponding to each training sample.

For the feedback behavior performed by the user, the server can first determine, based on the training sample, a pre-order service that corresponds to the training sample, that is, the historical conversation data and that is executed by the user. For example, after the user performs an order placing service, the server can actively contact the user by making an outgoing call, etc., to determine a risk of the order placing service. In this process, the server can store historical conversation data corresponding to current conversation, and the order placing service is the pre-order service that generates the historical conversation data.

Then, the server can determine, based on the preorder service, a subsequent service that corresponds to the preorder service and that is executed by the user. The subsequent service can be another service performed by the user based on the preorder service. In one or more embodiments of this specification, the subsequent service can be a complaint service. The server can determine, based on conversation data corresponding to the complaint service, a user intention corresponding to the conversation data as a feedback intention corresponding to the training sample, and use the feedback intention as a second label corresponding to the training sample.

Certainly, in one or more embodiments of this specification, the subsequent service can alternatively be another service such as an evaluation service or a return service executed by the user based on the preorder service. The evaluation service is used as an example. The server can determine, based on conversation data corresponding to the evaluation service, a user intention corresponding to the conversation data as a feedback intention corresponding to the training sample, and use the feedback intention as a second label corresponding to the training sample. A case in which the subsequent service is another service such as a return service is similar to this. Details are omitted here for simplicity.

If the user fails to normally complete the order due to fraud, the user makes a complaint about the order, and the complaint content is “I buy, online, a computer from Zhang San who I know online, and is cheated by Zhang San”, a user intention corresponding to the complaint content can be (transaction manner: online), (transaction object: Zhang San), (transaction objective: a valuable item have a risk), (fraud: confirmed), etc. Therefore, the user intention corresponding to the complaint content can be used as the complaint intention corresponding to the training sample, to be used as the second label corresponding to the training sample. The above-mentioned descriptions are merely an example. This specification sets no limitation on a specific manner in which a negative complaint feedback intention is embodied.

Certainly, the user usually does not perform the corresponding complaint service for a normally completed service. In this case, the second label corresponding to the training sample is empty, and it can be considered that the user intention obtained by the first intention recognition model through recognition as the first label is credible. After the user performs the complaint service for a service that cannot be normally executed due to a fraud, etc., the complaint intention can be obtained through recognition as the second label can be obtained based on complaint content. In this case, it can be considered that the user intention and the complaint intention obtained by the first intention recognition model through recognition jointly reflect a real intention of the user, and a combination of the user intention and the complaint intention is credible. Subsequently, a credible first risk identification result can be determined based on the first label and the second label, to train a to-be-trained intention recognition model.
S106: Determine a first risk identification result corresponding to the training sample based on the first label and the second label that correspond to the training sample.
S108: Input the training sample into a to-be-trained second intention recognition model, and determine each prediction intention and a second risk identification result that correspond to the training sample.

After the first label and the second label that correspond to the training sample are determined, in one or more embodiments of this specification, the server can first determine the first risk identification result corresponding to the training sample based on the first label and the second label that correspond to the training sample, to further train the to-be-trained second intention recognition model based on the first risk identification result.

Specifically, the server can pre-determine a combination of all risk intentions with a risk. For example, an intention combination (transaction manner: online and personal, transaction objective: a valuable article) can be used as a risk intention combination with a risk. Certainly, the risk intention combination does not limit a quantity of intentions in the intention combination. For example, (transaction objective: a virtual item has a risk) can be used as a risk intention combination with a risk, and this combination can only have the intention.

Then, the server can determine, based on each risk intention combination, whether a combination the first label and the second label that correspond to the training sample matches any risk intention combination; and if yes, determine that the first risk identification result corresponding to the training sample is that there is a risk; or if no, determine that the first risk identification result corresponding to the training sample is that there is no risk.

The second label can be considered as a supplement to the first label. Usually, an intention label determined by the first intention recognition model may not be completely accurate. For example, when the user is in a deceived state and cannot fully cooperate with conversation with the server to understand a situation, the user may give a false answer, and the first intention recognition model recognizes a false intention of the user based on the false answer of the user. However, after the user leaves the deceived state, the user may execute, to the server, a subsequent service such as a complaint service based on the preorder service that is executed by the user and that generates the corresponding historical conversation data. The complaint service is used as an example. The server can further determine the user intention corresponding to the conversation data based on the conversation data of the complaint service executed by the user, to determine the second label corresponding to the training sample. The first label is supplemented by the second label, so that the second label can supplement the first label to truly reflect the user intention corresponding to the training sample. The server can determine the credible first risk identification result based on the intention label and the complaint feedback intention that correspond to the training sample, and train the second intention recognition model based on the first risk identification result.

If a combination of the first label and the second label that correspond to the training sample is (transaction manner: online and personal, transaction objective: a virtual item has a risk), the risk intention combination is used as an example, and the first risk identification result corresponding to the training sample has a risk. If a combination of the first label and the second label that correspond to the training sample is (transaction manner: offline store, transaction objective: a physical object), the risk intention combination is still used as an example, and the first risk identification result corresponding to the training sample is that there is no risk.

After the first risk identification result is determined, the user can input the training sample into the to-be-trained intention recognition model, and determine each prediction intention and the second risk identification result that correspond to the training sample based on context of a plurality of rounds of conversation by combining the user reply and the plurality of rounds of conversation.

After obtaining each prediction intention corresponding to the training sample, the server can determine the second risk identification result based on each prediction intention, and subsequently can train the second intention recognition model based on the first risk identification result.

Specifically, the server can determine, based on each preset risk intention combination with a risk, whether a combination of all prediction intentions corresponding to the training sample matches any risk intention combination; and if yes, determine that the second risk identification result corresponding to the training sample is that there is a risk; or if no, determine that the second risk identification result corresponding to the training sample is that there is no risk. A specific process is the same as a process of determining the first risk identification result. For details, references can be made to the above-mentioned correspondence descriptions.

Certainly, in one or more embodiments of this specification, if the second intention recognition model passes through the pre-training process described in step S100 before step S108, the server can replace, with a second output layer, a first output layer of the second intention recognition model obtained through training. The second output layer is configured to output a prediction intention based on the training sample.

Then, the server can input the training sample into an input layer of the second intention recognition model obtained through training, and obtain each prediction intention corresponding to the training sample by using the second output layer.

In this case, for the intention recognition model obtained through pre-training, when the user intention corresponding to the training sample is determined based on the input training sample, objective intention recognition is not merely performed based on the user reply. After pre-training is performed by perform inference based on the context, the intention recognition model obtained through pre-training can perform intention recognition by combining a connection between the user reply and the plurality of rounds of conversation, to obtain a more accurate prediction intention through recognition. Training efficiency of the second intention recognition model is improved through pre-training.
S110: Determine a loss based on a difference between the first risk identification result and the second risk identification result of each training sample, and train the to-be-trained second intention recognition model with an optimization objective of minimizing the loss.

After the first risk identification result and the second risk identification result that correspond to the training sample are determined, the server can determine a loss based on a difference between the first risk identification result and the second risk identification result of each training sample, and train the to-be-trained second intention recognition model with an optimization objective of minimizing the loss.

A specific manner in which a loss is determined based on a specific algorithm can be determined based on a requirement. This is not limited in this specification. For example, 1 exists if the risk identification result is that there is a risk, and 0 exists if the risk identification result is that there is no risk. The loss can be determined based on the quadratic sum of the difference between the first risk identification result and the second risk identification result of each training sample.

After continuous iterative training, the intention recognition model can continuously improve accuracy of prediction intention in an iterative training process, to improve risk identification accuracy.

According to the intention recognition model training method shown in FIG. 1, historical conversation data including a plurality of rounds of conversation are first determined as a training sample; a user intention of each round of conversation in each training sample is determined by using a first intention recognition model; a feedback intention is determined based on a service that corresponds to the training sample and that is executed by a user; a first risk identification result is determined based on a user intention and the feedback intention that are of the training sample; each prediction intention of the training sample and a second risk identification result are determined by using a second intention recognition model; and finally, the second intention recognition model is trained with an optimization objective of minimizing a difference between the first risk identification result and the second risk identification result that are of each training sample. An accurate risk identification result is obtained with reference to the feedback intention and the user intention determined by the first intention recognition model, to train the second intention recognition model, thereby improving a risk identification capability of the second intention recognition model.

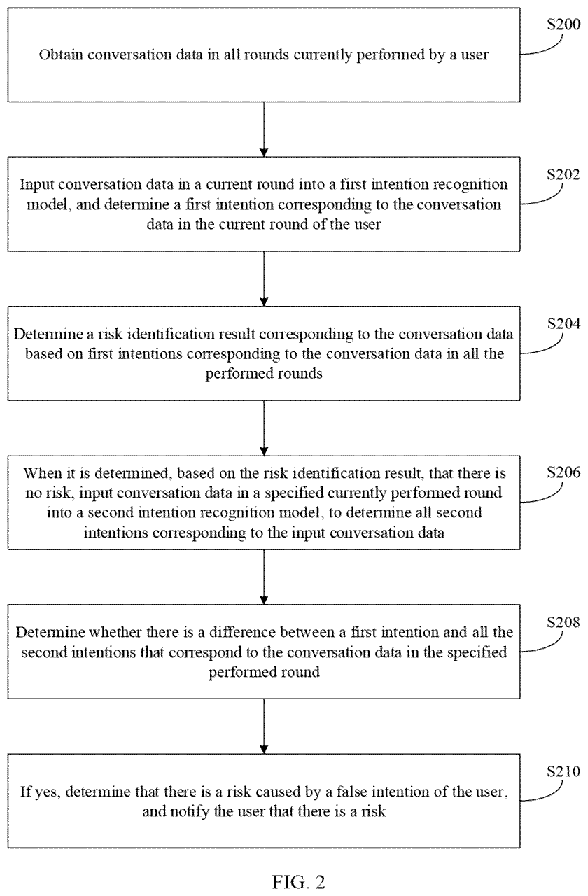

Based on the intention recognition model training method provided in FIG. 1, this specification further provides a user intention recognition method, as shown in FIG. 2.

FIG. 2 is a schematic diagram of a user intention recognition procedure in this specification. The following steps are specifically included. S200: Obtain conversation data in all rounds currently performed by a user.

Usually, a server of a service platform can complete communication with a user through a plurality of rounds of conversation by making an outgoing call, actively initiating conversation chatting, etc., to find an operation risk of the user in a timely manner and perform risk control.

Therefore, in one or more embodiments of this specification, the server of the service platform can obtain the conversation data in each round currently performed by the user, to recognize a user intention based on the conversation data in each performed round, and prompt a case in which the recognition result is that there is a risk.

The conversation data in each currently performed round can include a question put by the server in each of completed rounds of conversation until a current moment and a corresponding user reply. Certainly, for the question put by the server, only a code corresponding to a question template put by the server can be stored based on pre-coding of the question template, and the conversation data in each round can include the code of the question template put by the server in each round of conversation and a corresponding user reply. For specific content of the template question, references can be made to the corresponding descriptions in step S100. Details are omitted here for simplicity.

The server mentioned in this specification can be a server disposed on a service platform, or a device such as a desktop computer or a laptop computer that can execute the solution in this specification. For ease of description, the following provides descriptions only by using an example in which the server is an execution body.
S202: Input conversation data in a current round into a first intention recognition model, and determine a first intention corresponding to the conversation data in the current round of the user.
S204: Determine a risk identification result corresponding to the conversation data based on first intentions corresponding to the conversation data in all the performed rounds.
S206: When it is determined, based on the risk identification result, that there is no risk, input conversation data in a specified currently performed round into a second intention recognition model, to determine all second intentions corresponding to the input conversation data.

After training of the second intention recognition model is completed, the second intention recognition model obtained through training in the intention recognition model training method provided in this specification can be used in a risk control scenario.

Certainly, the server can first use the first intention recognition model, input conversation data in a current round into the first intention recognition model, and determine a first intention corresponding to the conversation data in the current round of the user. The first intention is all intentions obtained by correspondingly recognizing conversation data in a current round, and can include one or more intentions.

Then, the server can determine, based on each determined first intention, the first risk identification result corresponding to the conversation data in each perform round. Specifically, the server can store, round by round, all first intentions corresponding to conversation data in all rounds that are obtained by the first intention recognition model, and then determine, based on each preset risk intention combination with a risk, whether a combination of first intentions corresponding to the conversation data in all rounds, that is, a combination of all stored first intentions and a first intention corresponding to the conversation data in the current round, matches any risk intention combination. If yes, it is determined that a first risk identification result corresponding to the conversation data in the current round is that there is a risk, or if no, it is determined that a first risk identification result corresponding to the conversation data in the current round is that there is no risk. For specific content of the risk intention combination, references can be made to the above-mentioned corresponding descriptions in step S106. Details are omitted here for simplicity. Certainly, for each round of conversation, all first risk identification results determined in the current round are results obtained through recognition after the first intention corresponding to the conversation data in the current conversation is added. Therefore, the first risk identification result determined in the current round can also be referred to as the conversation data corresponding to the current conversation.

When determining that the first intention has a risk, the server can directly determine the risk, and notify the user that a pre-service that corresponds to the current conversation of the user and that is executed by the user has a risk. For specific content of the preorder service, references can be made to the corresponding descriptions in step S106. Details are omitted here for simplicity.

When it is determined that the first intention has not risk, there are usually two possibilities. One is that an operation of the user is a normal operation, and there is no risk. The other is that the user is deceived and cannot fully cooperate with a conversation initiated by the server of the service platform. That is, the user chooses to lie for a question of the server, and gives a false answer. The first intention recognition model obtains the false intention based on the false answer of the user.

In this case, the server can input conversation data in a specified currently performed round into a second intention recognition model, to determine all second intentions corresponding to the input conversation data. The specified round can be determined based on a requirement or a setting of a model input parameter. This is not limited in this specification. Certainly, even if a quantity of performed rounds of conversation is less than a specified quantity of rounds, the server can input conversation data in all performed rounds into the second intention recognition model. In addition, the specified quantity of rounds can be selected to be partially input to the second intention recognition model when there is a relatively large quantity of performed rounds of conversation. Certainly, the specified quantity of rounds here can further be a quantity of rounds of inputs into the second intention recognition model each time. In this case, even if a quantity of performed rounds of conversation is greater than a specified quantity of rounds, the server can still input conversation data in all performed rounds into the second intention recognition model in batches. Certainly, usually, input conversation data in a larger quantity of rounds leads to a higher accuracy of performing intention recognition by the model, and correspondingly, a longer time required for running the model leads to worse timeliness of feeding back a recognition result.

The second intention recognition model here is obtained through training by using several pieces of historical conversation data as training samples and based on a first risk identification result determined based on a feedback intention corresponding to each training sample and a user intention determined by the first intention recognition model and each prediction intention and a second risk identification result that are determined by the second intention recognition model. The second intention recognition model can be specifically obtained through training in any one of the provided intention recognition model training methods.
S208: Determine whether there is a difference between the first intention and all the second intentions that correspond to the conversation data in the specified performed round, and perform S210 if yes.
S210: Determine that there is a risk caused by a false intention of the user, and notifying the user that there is a risk.

After each first intention and each second intention are determined as described above, in one or more embodiments of this specification, the server can determine, based on each first intention and each second intention, whether there is a difference between each first intention and each second intention.

Specifically, the server can determine, based on each determined first intention and, whether there is a difference between each first intention and each second intention. If there is a difference, it indicates that a user reply that may be given by the user in the current round of conversation conflicts with information displayed by the conversation data in the current round. The user may give a false user reply in the current round of conversation, and the user may be in a deceived state. A service performed by the user corresponding to the current conversation may have a risk caused by a false intention of the user, and the server can notify the user in a timely manner. If there is no difference, it indicates that a user performs relatively consistent in an entire conversation process, and information displayed in all the performed rounds of conversation does not conflict, the user can continue to perform the next round of conversation until the entire conversation process is completed.

In addition, in one or more embodiments of this specification, in step S206, when the server inputs the conversation data in the specified currently performed round into the second intention recognition model, to determine all the second intentions corresponding to the input conversation data, because the second intention recognition model is used to perform intention recognition based on the conversation data in the plurality of rounds of the user, it may be difficult to obtain a relatively accurate recognition result. Therefore, the server can further determine, based on a preset quantity of rounds of conversation, whether a quantity of current rounds of conversation is less than the preset quantity of rounds of conversation, and if yes, continue to continue to the next round of conversation, until a quantity of rounds of conversation reaches the preset quantity of rounds of conversation; or if no, the server can input the conversation data in the specified currently performed round into the second intention recognition model, to determine all the second intentions corresponding to the conversation data in the current round of the user. For specific content of determining each second intention, references can be made to the above-mentioned corresponding descriptions. Details are omitted here for simplicity.

In addition, in one or more embodiments of this specification, in step S206, when the server inputs the conversation data in the specified currently performed round into the second intention recognition model, to determine all the second intentions corresponding to the conversation data in the current round of the user, the server can further determine the specified round based on a length of the conversation data. In this case, the server can input the conversation data in the performed rounds into the second intention recognition model in batches based on the length of the conversation data in the performed rounds, and conversation data in different quantities of rounds can be input to the second intention recognition model each time, so that the conversation data is more flexibly input.

In addition, in one or more embodiments of this specification, in step S208, when determining whether there is a difference between the first intention and each second intention that correspond to the conversation data in the specified performed round, the server can first determine, based on each preset risk intention combination, whether a combination of all the second intentions matches any risk intention combination; and if yes, determine that there is a risk caused by a false intention of the user, and notify the user that there is a risk; or if no, determine whether there is a difference between the first intention and all the second intentions that correspond to the conversation data in the specified performed round. That is, a second time of determining is first performed based on each determined second intention, to determine whether a result is consistent with the determined first risk identification result. If consistent, determining is further performed; or if inconsistent, it indicates that the user can be in a deceived state. A service that corresponds to the current conversation and that is executed by the user may have a risk caused by the false intention of the user, and the server can notify the user in a timely manner.

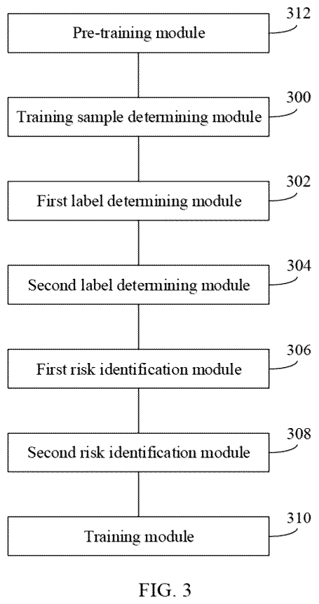

The intention recognition model training method provided in one or more embodiments of this specification is described above. Based on the same idea. This specification further provides a corresponding intention recognition model training apparatus, as shown in FIG. 3.

FIG. 3 is a schematic diagram of an intention recognition model training apparatus based on this specification. The apparatus includes: a training sample determining module 300, configured to determine each training sample based on historical conversation data, where the training sample includes a plurality of rounds of conversation; a first label determining module 302, configured to: for each training sample, determine, as a first label of the training sample, a user intention of each round of conversation in the training sample by using a first intention recognition model whose training is completed; a second label determining module 304, configured to: determine, based on the training sample, a preorder service that corresponds to the training sample and that is executed by a user, to determine a subsequent service that corresponds to the preorder service and that is executed by the user, and determine, as a second label corresponding to the training sample, a feedback intention based on conversation data corresponding to the subsequent service; a first risk identification module 306, configured to determine a first risk identification result corresponding to the training sample based on the first label and the second label that correspond to the training sample; a second risk identification module 308, configured to: input the training sample into a to-be-trained second intention recognition model, and determine each prediction intention and a second risk identification result that correspond to the training sample; and a training module 310, configured to: determine a loss based on a difference between the first risk identification result and the second risk identification result of each training sample, and train the to-be-trained second intention recognition model with an optimization objective of minimizing the loss, where the second intention recognition model is used to jointly recognize, with the first intention recognition model, a risk caused by a false intention of the user in conversation.

Optionally, the apparatus further includes: a pre-training module 312, configured to: replace at least a part of user replies in each round of conversation in the training sample with a placeholder, to obtain each pre-training sample, and determine a conversation label of each pre-training sample based on the replaced user replies; input each pre-training sample into an input layer of the to-be-trained second intention recognition model, and determine a prediction statement corresponding to each replaced user reply by using a first output layer of the second intention recognition model; and pre-train the to-be-trained second intention recognition model with an optimization objective of minimizing a difference between the prediction statement and the conversation label that correspond to each pre-training sample, until a training end condition is reached, to determine a second intention recognition model obtained through pre-training.

Optionally, the second risk identification module 308 is configured to: replace, with a second output layer, a first output layer of the second intention recognition model obtained through training, where the second output layer is configured to output a prediction intention; and input the training sample into an input layer of the second intention recognition model obtained through training, and obtaining each prediction intention corresponding to the training sample by using the second output layer.

Optionally, the second label determining module 304 is configured to: determine, based on the historical conversation data corresponding to the training sample, a preorder service that generates the historical conversation data; determine, based on the preorder service, a complaint service that corresponds to the preorder service and that is executed by the user; and determine, as the feedback intention corresponding to the training sample based on conversation data corresponding to the determined complaint service, a user intention corresponding to the conversation data.

Optionally, the first risk identification module 306 is configured to: determine, based on each preset risk intention combination, whether a combination of the first label and the second label that correspond to the training sample matches any risk intention combination; and if yes, determine that the first risk identification result corresponding to the training sample is that there is a risk; or if no, determine that the first risk identification result corresponding to the training sample is that there is no risk.

Optionally, the second risk identification module 308 is configured to: determine, based on each preset risk intention combination, whether a combination of all prediction intentions corresponding to the training sample matches any risk intention combination; and if yes, determine that the second risk identification result corresponding to the training sample is that there is a risk; or if no, determine that the second risk identification result corresponding to the training sample is that there is no risk.

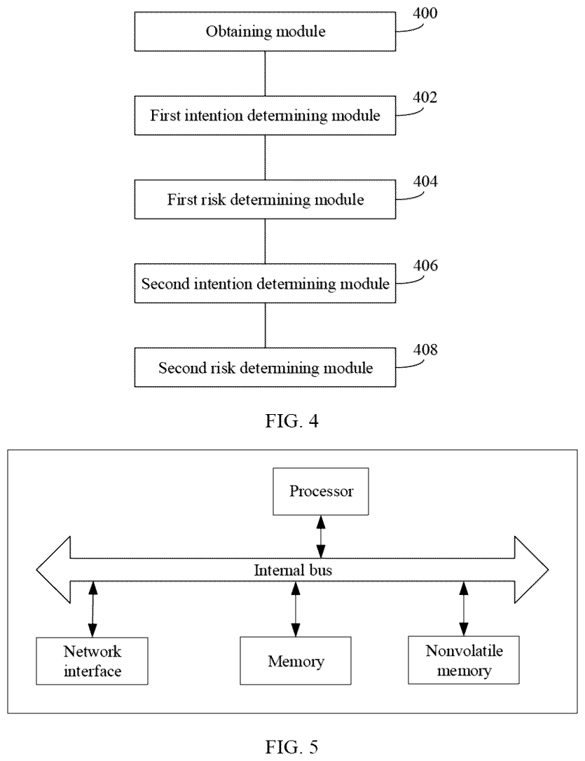

Based on the user intention recognition method provided in one or more embodiments of this specification, this specification further provides a corresponding user intention recognition apparatus, as shown in FIG. 4.

FIG. 4 is a schematic diagram of a user intention recognition apparatus according to this specification. The apparatus includes: an obtaining module 400, configured to obtain conversation data in all rounds currently performed by a user; a first intention determining module 402, configured to: input conversation data in a current round into a first intention recognition model, and determine a first intention corresponding to the conversation data in the current round of the user;
a first risk determining module 404, configured to determine a risk identification result corresponding to the conversation data based on first intentions corresponding to the conversation data in all the performed rounds; a second intention determining module 406, configured to: when it is determined, based on the risk identification result, that there is no risk, input conversation data in a specified currently performed round into a second intention recognition model, to determine all second intentions corresponding to the input conversation data; and a second risk determining module 408, configured to: determine whether there is a difference between a first intention and all the second intentions that correspond to the conversation data in the specified performed round; and if yes, determine that there is a risk caused by a false intention of the user, and notify the user that there is a risk.

Optionally, the second risk determining module 408 is configured to: determine, based on each preset risk intention combination, whether a combination of all the second intentions matches any risk intention combination; and if yes, determine that there is a risk caused by a false intention of the user, and notify the user that there is a risk; or if no, determine whether there is a difference between the first intention and all the second intentions that correspond to the conversation data in the specified performed round.

Optionally, the first risk determining module 404 is configured to: determine, based on each preset risk intention combination, whether a combination of the first intentions corresponding to the conversation data in all the performed rounds matches any risk intention combination; and if yes, determine that the risk identification result corresponding to the conversation data is that there is a risk; or if no, determine that the risk identification result corresponding to the conversation data is that there is no risk.

This specification further provides a non-transitory computer-readable storage medium. The storage medium stores a computer program, and the computer program can be used to perform the intention recognition model training method provided in FIG. 1 or the user intention recognition method provided in FIG. 2.

This specification further provides a schematic structural diagram of an electronic device shown in FIG. 5. As shown in FIG. 5, in terms of hardware, the electronic device includes a processor, an internal bus, a network interface, a memory, and a nonvolatile memory, and certainly can further include hardware needed by another service. The processor reads a corresponding computer program from the nonvolatile memory into the memory and then runs the computer program, to implement the intention recognition model training method provided in FIG. 1 or the user intention recognition method provided in FIG. 2.

Certainly, in addition to software implementations, another implementation is not excluded in this specification, for example, a logic device or a combination of hardware and software. In other words, an execution body of the following processing process is not limited to logical units, and can be hardware or a logic device.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers program an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and manufacture an application-specific integrated circuit chip. In addition, at present, instead of manually manufacturing an integrated circuit chip, this type of programming is mostly implemented by using “logic compiler” software. The programming is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. It should also be clear to a person skilled in the art that a hardware circuit for implementing a logical method procedure can be easily obtained by performing slight logic programming on the method procedure by using the above-mentioned several hardware description languages and programming the method procedure into an integrated circuit.

A controller can be implemented by using any appropriate method. For example, the controller can be a microprocessor or a processor, or a computer readable medium that stores computer-readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. A storage controller can also be implemented as a part of the control logic of the storage. A person skilled in the art also knows that in addition to implementing the controller by using only the computer-readable program code, logic programming can be performed on method steps to enable the controller to implement the same function in a form of a logic gate, a switch, an application specific integrated circuit, a programmable logic controller, or an embedded microcontroller. Therefore, the controller can be considered as a hardware component, and an apparatus configured to implement various functions in the controller can also be considered as a structure in the hardware component. Alternatively, an apparatus configured to implement various functions can even be considered as both a software module implementing the method and a structure in the hardware component.

The systems, apparatuses, modules, or units described in the above-mentioned embodiments can be specifically implemented by a computer chip or an entity, or can be implemented by a product having a certain function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, when this specification is implemented, functions of the units can be implemented in one or more pieces of software and/or hardware.

A person skilled in the art should understand that an embodiment of this specification can be provided as a method, a system, or a computer program product. Therefore, this specification can use a form of hardware only embodiments, software only embodiments, or embodiments with a combination of software and hardware. Moreover, a form of a computer program product that is implemented on one or more computer-usable storage media (including but not limited to a disk memory, a CD-ROM, an optical memory, etc.) that include computer-usable program code can be used in this specification.

This specification is described with reference to the flowcharts and/or block diagrams of the method, the device (system), and the computer program product based on the embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more processes in the flowcharts and/or in one or more blocks in the block diagrams.

Alternatively, these computer program instructions can be stored in a computer-readable storage that can instruct a computer or another programmable data processing device to work in a specific manner, so the instructions stored in the computer-readable storage generate an artifact that includes an instruction apparatus. The instruction apparatus implements a specific function in one or more procedures in the flowcharts and/or in one or more blocks in the block diagrams.

These computer program instructions may also be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more processes in the flowcharts/or in one or more blocks in the block diagrams.

In a typical configuration, a computing device includes one or more processors (CPUs), one or more input/output interfaces, one or more network interfaces, and one or more memories.

The memory can include a form of a volatile memory, a random access memory (RAM), a nonvolatile memory, and/or the like in a computer-readable medium, such as a read-only memory (ROM) or a flash memory (flash RAM). The memory is an example of the computer-readable medium.

The computer-readable medium includes persistent, non-persistent, removable and non-removable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD) or another optical storage, a cassette, a cassette magnetic disk storage, or another magnetic storage device or any other non-transmission medium. The computer storage medium can be configured to store information that can be accessed by a computing device. Based on the definition in this specification, the computer-readable medium does not include transitory media such as a modulated data signal and carrier.

It should be further noted that the terms “include”, “comprise”, or any other variant thereof are intended to cover a non-exclusive inclusion, so that a process, a method, a product, or a device that includes a list of elements not only includes those elements but also includes other elements which are not expressly listed, or further includes elements inherent to such process, method, product, or device. Without more constraints, an element preceded by “includes a . . . ” does not preclude the existence of additional identical elements in the process, method, product, or device that includes the element.

A person skilled in the art should understand that the embodiments of this specification can be provided as methods, systems, or computer program products. Therefore, a form of hardware only embodiments, software only embodiments, or embodiments with a combination of software and hardware can be used in this specification. In addition, a form of a computer program product that is implemented on one or more computer-usable storage media (including but not limited to a disk memory, a CD-ROM, an optical memory, etc.) that include computer-usable program code can be used in this specification.

This specification can be described in the general context of computer-executable instructions, for example, a program module. Usually, the program module includes a routine, a program, an object, a component, a data structure, etc. executing a specific task or implementing a specific abstract data type. This specification can alternatively be practiced in distributed computing environments in which tasks are performed by remote processing devices that are connected through a communication network. In the distributed computing environments, the program module can be located in both local and remote computer storage media including storage devices.

The embodiments in this specification are described in a progressive manner. For the same or similar parts of the embodiments, references can be made to the embodiments. Each embodiment focuses on a difference from other embodiments. Particularly, the system embodiments are basically similar to the method embodiments, and therefore are described briefly. For related parts, references can be made to some descriptions in the method embodiments.

The above-mentioned descriptions are merely embodiments of this specification, and are not intended to limit this specification. A person skilled in the art can make various changes and variations to this specification. Any modification, equivalent replacement, or improvement made without departing from the spirit and principle of this specification shall fall within the scope of the claims in this specification.

1. An intention recognition model training method, wherein the method comprises:
determining each training sample based on historical conversation data, wherein the training sample comprises a plurality of rounds of conversation;
for each training sample, determining, as a first label of the training sample, a user intention of each round of conversation in the training sample by using a first intention recognition model whose training is completed;
determining, based on the training sample, a preorder service that corresponds to the training sample and that is executed by a user, to determine a subsequent service that corresponds to the preorder service and that is executed by the user, and determining, as a second label corresponding to the training sample, a feedback intention based on conversation data corresponding to the subsequent service;
determining a first risk identification result corresponding to the training sample based on the first label and the second label that correspond to the training sample;
inputting the training sample into a to-be-trained second intention recognition model, and determining each prediction intention and a second risk identification result that correspond to the training sample; and
determining a loss based on a difference between the first risk identification result and the second risk identification result of each training sample, and training the to-be-trained second intention recognition model with an optimization objective of minimizing the loss, wherein the second intention recognition model is used to jointly recognize, with the first intention recognition model, a risk caused by a false intention of the user in conversation.

2. The method according to claim 1, wherein before the inputting the training sample into a to-be-trained second intention recognition model, and determining each prediction intention and a second risk identification result that correspond to the training sample, the method further comprises:
replacing at least a part of user replies in each round of conversation in the training sample with a placeholder, to obtain each pre-training sample, and determining a conversation label of each pre-training sample based on the replaced user replies;
inputting each pre-training sample into an input layer of the to-be-trained second intention recognition model, and determining a prediction statement corresponding to each replaced user reply by using a first output layer of the second intention recognition model; and
pre-training the to-be-trained second intention recognition model with an optimization objective of minimizing a difference between the prediction statement and the conversation label that correspond to each pre-training sample, until a training end condition is reached, to determine a second intention recognition model obtained through pre-training.

3. The method according to claim 2, wherein the inputting the training sample into a to-be-trained second intention recognition model, and determining each prediction intention corresponding to the training sample specifically comprises:
replacing, with a second output layer, a first output layer of the second intention recognition model obtained through training, wherein the second output layer is configured to output a prediction intention; and
inputting the training sample into an input layer of the second intention recognition model obtained through training, and obtaining each prediction intention corresponding to the training sample by using the second output layer.

4. The method according to claim 1, wherein the determining a preorder service that corresponds to the training sample and that is executed by a user, to determine a subsequent service that corresponds to the preorder service and that is executed by the user, and determining a feedback intention based on conversation data corresponding to the subsequent service specifically comprises:
determining, based on the historical conversation data corresponding to the training sample, a preorder service that generates the historical conversation data;
determining, based on the preorder service, a complaint service that corresponds to the preorder service and that is executed by the user; and
determining, as the feedback intention corresponding to the training sample based on conversation data corresponding to the determined complaint service, a user intention corresponding to the conversation data.

5. The method according to claim 1, wherein the determining a first risk identification result corresponding to the training sample based on the first label and the second label that correspond to the training sample specifically comprises:
determining, based on each preset risk intention combination, whether a combination of the first label and the second label that correspond to the training sample matches any risk intention combination; and
upon determining that the combination of the first label and the second label that correspond to the training sample matches a risk intention combination, determining that the first risk identification result corresponding to the training sample is that there is a risk; or
upon determining that the combination of the first label and the second label that correspond to the training sample does not match any risk intention combination, determining that the first risk identification result corresponding to the training sample is that there is no risk.

6. The method according to claim 1, wherein the determining a second risk identification result that correspond to the training sample specifically comprises:
determining, based on each preset risk intention combination, whether a combination of all prediction intentions corresponding to the training sample matches any risk intention combination; and
upon determining that the combination of all prediction intentions corresponding to the training sample matches a risk intention combination, determining that the second risk identification result corresponding to the training sample is that there is a risk; or
upon determining that the combination of all prediction intentions corresponding to the training sample does not match any risk intention combination, determining that the second risk identification result corresponding to the training sample is that there is no risk.

7. A user intention recognition method, wherein the method comprises:
obtaining conversation data in all rounds currently performed by a user;
inputting conversation data in a current round into a first intention recognition model, and determining a first intention corresponding to the conversation data in the current round of the user;
determining a risk identification result corresponding to the conversation data based on first intentions corresponding to the conversation data in all the performed rounds;
when it is determined, based on the risk identification result, that there is no risk, inputting conversation data in a specified currently performed round into a second intention recognition model, to determine all second intentions corresponding to the input conversation data;
determining whether there is a difference between a first intention and all the second intentions that correspond to the conversation data in the specified performed round; and
upon determining that there is a difference between a first intention and all the second intentions that correspond to the conversation data in the specified performed round, determining that there is a risk caused by a false intention of the user, and notifying the user that there is a risk, wherein
the second intention recognition model is obtained through training by using several pieces of historical conversation data as training samples and based on a first risk identification result determined based on a feedback intention corresponding to each training sample and a user intention determined by the first intention recognition model and each prediction intention and a second risk identification result that are determined by the second intention recognition model.

8. The method according to claim 7, wherein the determining whether there is a difference between a first intention and all the second intentions that correspond to the conversation data in the specified performed round specifically comprises:
determining, based on each preset risk intention combination, whether a combination of all the second intentions matches any risk intention combination; and
upon determining that the combination of all the second intentions matches a risk intention combination, determining that there is a risk caused by a false intention of the user, and notifying the user that there is a risk; or
upon determining that the combination of all the second intentions does not match any risk intention combination, determining whether there is a difference between the first intention and all the second intentions that correspond to the conversation data in the specified performed round.

9. The method according to claim 7, wherein the determining a risk identification result corresponding to the conversation data based on first intentions corresponding to the conversation data in all the performed rounds specifically comprises:
determining, based on each preset risk intention combination, whether a combination of the first intentions corresponding to the conversation data in all the performed rounds matches any risk intention combination; and
upon determining that the combination of the first intentions corresponding to the conversation data in all the performed rounds matches a risk intention combination, determining that the risk identification result corresponding to the conversation data is that there is a risk; or
upon determining that the combination of the first intentions corresponding to the conversation data in all the performed rounds does not match any risk intention combination, determining that the risk identification result corresponding to the conversation data is that there is no risk.

10-12. (canceled)

13. An electronic device, comprising a storage, a processor, and a computer program that is stored in the storage and that is capable of running on the processor, wherein when the processor executes the program, the processor implements an intention recognition model training method, and the method comprises:
determining each training sample based on historical conversation data, wherein the training sample comprises a plurality of rounds of conversation;
for each training sample, determining, as a first label of the training sample, a user intention of each round of conversation in the training sample by using a first intention recognition model whose training is completed;
determining, based on the training sample, a preorder service that corresponds to the training sample and that is executed by a user, to determine a subsequent service that corresponds to the preorder service and that is executed by the user, and determining, as a second label corresponding to the training sample, a feedback intention based on conversation data corresponding to the subsequent service;
determining a first risk identification result corresponding to the training sample based on the first label and the second label that correspond to the training sample;
inputting the training sample into a to-be-trained second intention recognition model, and determining each prediction intention and a second risk identification result that correspond to the training sample; and
determining a loss based on a difference between the first risk identification result and the second risk identification result of each training sample, and training the to-be-trained second intention recognition model with an optimization objective of minimizing the loss, wherein the second intention recognition model is used to jointly recognize, with the first intention recognition model, a risk caused by a false intention of the user in conversation.

14. The electronic device according to claim 13, wherein before the inputting the training sample into a to-be-trained second intention recognition model, and determining each prediction intention and a second risk identification result that correspond to the training sample, the computing device is further caused to:
replace at least a part of user replies in each round of conversation in the training sample with a placeholder, to obtain each pre-training sample, and determine a conversation label of each pre-training sample based on the replaced user replies;
input each pre-training sample into an input layer of the to-be-trained second intention recognition model, and determine a prediction statement corresponding to each replaced user reply by using a first output layer of the second intention recognition model; and
pre-train the to-be-trained second intention recognition model with an optimization objective of minimizing a difference between the prediction statement and the conversation label that correspond to each pre-training sample, until a training end condition is reached, to determine a second intention recognition model obtained through pre-training.

15. The electronic device according to claim 14, wherein the input the training sample into a to-be-trained second intention recognition model, and determine each prediction intention corresponding to the training sample specifically comprises:
replace, with a second output layer, a first output layer of the second intention recognition model obtained through training, wherein the second output layer is configured to output a prediction intention; and
input the training sample into an input layer of the second intention recognition model obtained through training, and obtain each prediction intention corresponding to the training sample by using the second output layer.

16. The electronic device according to claim 13, wherein the determining a preorder service that corresponds to the training sample and that is executed by a user, to determine a subsequent service that corresponds to the preorder service and that is executed by the user, and determining a feedback intention based on conversation data corresponding to the subsequent service specifically comprises:
determining, based on the historical conversation data corresponding to the training sample, a preorder service that generates the historical conversation data;
determining, based on the preorder service, a complaint service that corresponds to the preorder service and that is executed by the user; and
determining, as the feedback intention corresponding to the training sample based on conversation data corresponding to the determined complaint service, a user intention corresponding to the conversation data.

17. The electronic device according to claim 13, wherein the determining a first risk identification result corresponding to the training sample based on the first label and the second label that correspond to the training sample specifically comprises:
determining, based on each preset risk intention combination, whether a combination of the first label and the second label that correspond to the training sample matches any risk intention combination; and
upon determining that the combination of the first label and the second label that correspond to the training sample matches a risk intention combination, determining that the first risk identification result corresponding to the training sample is that there is a risk; or
upon determining that the combination of the first label and the second label that correspond to the training sample does not match any risk intention combination, determining that the first risk identification result corresponding to the training sample is that there is no risk.

18. The electronic device according to claim 13, wherein the determining a second risk identification result that correspond to the training sample specifically comprises:
determining, based on each preset risk intention combination, whether a combination of all prediction intentions corresponding to the training sample matches any risk intention combination; and
upon determining that the combination of all prediction intentions corresponding to the training sample matches a risk intention combination, determining that the second risk identification result corresponding to the training sample is that there is a risk; or
upon determining that the combination of all prediction intentions corresponding to the training sample does not match any risk intention combination, determining that the second risk identification result corresponding to the training sample is that there is no risk.

19. The electronic device according to claim 13, the computing device is further caused to a user intention recognition method, wherein the method comprises:
obtaining conversation data in all rounds currently performed by a user;
inputting conversation data in a current round into a first intention recognition model, and determining a first intention corresponding to the conversation data in the current round of the user;
determining a risk identification result corresponding to the conversation data based on first intentions corresponding to the conversation data in all the performed rounds;
when it is determined, based on the risk identification result, that there is no risk, inputting conversation data in a specified currently performed round into a second intention recognition model, to determine all second intentions corresponding to the input conversation data;
determining whether there is a difference between a first intention and all the second intentions that correspond to the conversation data in the specified performed round; and
upon determining that there is a difference between a first intention and all the second intentions that correspond to the conversation data in the specified performed round, determining that there is a risk caused by a false intention of the user, and notifying the user that there is a risk, wherein
the second intention recognition model is obtained through training by using several pieces of historical conversation data as training samples and based on a first risk identification result determined based on a feedback intention corresponding to each training sample and a user intention determined by the first intention recognition model and each prediction intention and a second risk identification result that are determined by the second intention recognition model.

20. The electronic device according to claim 19, wherein the determining whether there is a difference between a first intention and all the second intentions that correspond to the conversation data in the specified performed round specifically comprises:
determining, based on each preset risk intention combination, whether a combination of all the second intentions matches any risk intention combination; and
upon determining that the combination of all the second intentions matches a risk intention combination, determining that there is a risk caused by a false intention of the user, and notifying the user that there is a risk; or
upon determining that the combination of all the second intentions does not match any risk intention combination, determining whether there is a difference between the first intention and all the second intentions that correspond to the conversation data in the specified performed round.

21. The electronic device according to claim 19, wherein the determining a risk identification result corresponding to the conversation data based on first intentions corresponding to the conversation data in all the performed rounds specifically comprises:
determining, based on each preset risk intention combination, whether a combination of the first intentions corresponding to the conversation data in all the performed rounds matches any risk intention combination; and
upon determining that the combination of the first intentions corresponding to the conversation data in all the performed rounds matches a risk intention combination, determining that the risk identification result corresponding to the conversation data is that there is a risk; or
upon determining that the combination of the first intentions corresponding to the conversation data in all the performed rounds does not match any risk intention combination, determining that the risk identification result corresponding to the conversation data is that there is no risk.
